(19) United States
(12) Patent Application Publication
(10) Pub. No.: US 2010/0230083 A1
(43) Pub. Date: Sep. 16, 2010

(54) TUBE HAVING AN INCREASED INTERNAL SURFACE, USED IN FURNACES, MANUFACTURING PROCESS AND APPLICATIONS

(75) Inventors: Gilles Verdier, Mont Saint Aignan (FR); Pierre Emmanuel Nioche, Le Manoir Sur Seine (FR)

Correspondence Address: LEYDIG VOIT & MAYER, LTD, 700 THIRTEENTH ST. NW, SUITE 300, WASHINGTON, DC, 20005-3960, US

(73) Assignee: MANOIR INDUSTRIES, Paris (FR)

(21) Appl. No.: 12/738,673

(22) PCT Filed: Feb. 1, 2008
(86) PCT No.: PCT/FR08/50170

§ 371 Date: Jun. 1, 2010

(30) Foreign Application Priority Data
Oct. 19, 2007 (FR) 0758445

(51) Int. Cl. F28F 1/40; F22B 37/06; B23K 15/00; B23K 26/00

(52) U.S. Cl. 165/181; 122/511; 219/121.14; 219/121.64

(57) ABSTRACT

A tube used in furnaces includes at least one attached radial bar fastened by welding to the internal face of the wall of the tube. A method of manufacturing such a tube includes at least one electron-beam of laser-beam welding step, in which at least one attached radial bar is welded, from outside the tube, to the internal face of the wall of the tube. The tubes may be used in reforming, steam-cracking or DRI furnaces.

### FIELD OF THE INVENTION

The invention relates primarily to a tube having an increased internal surface which is used in furnaces.

The invention also relates to a process for manufacturing such a tube.

### BACKGROUND

The furnaces in the field of application of the invention are petrochemical furnaces, but also heating furnaces for direct reduction iron (DRI) facilities.

There are two types of furnaces used in petrochemical plants. Steam cracking furnaces in which ethylene is produced, and steam reforming furnaces producing hydrogen and carbon monoxide.

These furnaces include a convection portion serving to preheat the products to be treated and a radiation portion in which the reforming or cracking reaction takes place.

The radiation of these furnaces is made up of tubes with long lengths at the inlets of which one injects the product to be treated preheated beforehand in the convection, i.e. methane for reforming, and ethane, propane, butane, naphtha and heavier hydrocarbons for cracking.

In these two types of furnaces, steam is also injected.

These tubes, made of a refractory material, are heated radially. They are arranged generally vertically but can also be arranged horizontally, in particular in the old furnaces.

The gases circulating in the tubes and the heat present inside the tube causes the rupture of their carbon chains.

At the outlet of the tube, one recovers ethylene and propylene for the steam cracking furnaces and hydrogen and carbon monoxide for the reforming furnaces.

DRI furnaces also involve the use of tubes with long lengths.

These furnaces operate similarly to the reforming and cracking furnaces previously described.

More specifically, the iron ore reduction gas previously developed in a reforming furnace is made to circulate in these tubes. These tubes thus undergo stresses similar to the tubes of the petrochemical furnaces.

The tubes previously described must be made in an alloy allowing them to operate at temperatures in the vicinity of 1000° C. for steam reforming furnaces, 1100° C. for steam cracking furnaces and between 1000 and 1100° C. for DRI furnaces.

The tubes must therefore resist creep, i.e. mechanical deformations at high temperatures, with the understanding that the pressure in the reforming furnaces can reach 30 bar, but they must also resist oxidation in the atmosphere of the furnaces.

Moreover, for steam cracking furnaces, it is crucial to use a material limiting carburizing where coke deposits appear on the internal surface of the tube.

For a number of years, the Applicant has been developing alloys with austenitic structure meeting these criteria.

These alloys are iron-, nickel- and chrome-based.

Nickel makes it possible to stabilizer the austenitic structure. Nickel and chrome participate in corrosion reduction (carburizing, oxidation . . . ).

These alloys also contain carbon. The carbon forms carbides which oppose the deformation of the metal at high temperature and therefore make it possible to increase creep resistance.

To improve the resistance of the tubes to creep, elements forming carbides such as niobium, titanium, tungsten and molybdenum can be added.

Also used is silicon, which contributes to increasing corrosion resistance.

The mixture of all of these components in specific proportions makes it possible to obtain high-quality tubes, usable in steam cracking, steam reforming and DRI furnaces.

As an example, the Applicant has been marketing tubes for steam cracking furnaces for a number of years under the MANAURITE® XM and MANAURITE® XTM trademarks, the respective chemical compositions of which are the following:

MANAURITE ® XM

| Element | Percentage |
|---|---|
| C | 0.45-0.50 |
| Mn | 0-1.5 |
| Si | 1-2 |
| P | 0-0.03 |
| S | 0-0.03 |
| Ni | 33-36 |
| Cr | 24-27 |
| Mo | 0-0.5 |
| Nb | 0.5-1 |
| Ti, Zr, W | Additions |

The rest being made of iron.

MANAURITE ® XTM

| Element | Percentage |
|---|---|
| C | 0.40-0.50 |
| Mn | 0-1.5 |
| Si | 1-2 |
| P | 0-0.03 |
| S | 0-0.03 |
| Ni | 43-48 |
| Cr | 34-37 |
| Nb | 0.5-1 |
| Ti, Zr, W | Additions |

The tubes used in the furnaces have a length in the vicinity of several meters, generally 3 to 6 meters. Their internal diameter is from 35 to 200 millimeters.

These tubes generally have a circular internal and external cross-section. Their thickness is in the vicinity of five to twenty millimeters.

The tubes used in the petrochemical furnaces can sometimes be made by forging.

Nevertheless, when a significant quantity of carbon is present in the alloy, as is the case for Manaurite XM and Manaurite XTM, forging of the tubes is impossible. These tubes are then manufactured by centrifugal casting.

To increase the effectiveness of the tubes used in steam cracking, steam reforming and DRI furnaces, it is known to increase the internal surface of the tubes. Indeed, increasing the heating surface causes a more significant heat transfer between the exterior and interior of the tube, and therefore an increased reactive effectiveness.

European patent EP 980 729 proposes, to that end, a tube including, on its internal face, protuberances and hollows formed through an electrochemical method.

This method consists of using an electrode whereof the external surface is made up of hollows and protuberances like those one wishes to obtain on the internal face of the tube.

The circulation of an electrolyte between the electrode and the internal face of the tube, and the pushing of this electrode inside the tube will cause, through the concomitant passage of an electrical current, the dissolution of the material at the level of the internal face of the tube, and the formation of hollows and protuberances corresponding to the hollows and protuberances of the electrode.

Also known, from international patent application WO 03/011507, is a mechanical method by broaching making it possible to realize hollows and protuberances on the internal face of the tubes of petrochemical furnaces.

This method consists of scratching the material inside the tube using a pin introduced into said tube. The pin includes cutting tools, the shape of which corresponds to the shape of the hollows and protuberances one wishes to obtain on the internal face of the tube.

This method requires several passages of the broaching tool in the tube, the change of cutting tools between each passage and the recovery of shavings generated by a passage of the broaching tool in the tube.

Although the two aforementioned methods make it possible to increase the internal surface of the tubes used in petrochemical furnaces, they are difficult to implement and lead to the use of complex and costly devices.

### SUMMARY OF THE INVENTION

The invention is situated in this context and makes it possible to offset the aforementioned drawbacks by proposing a tube with an increased internal surface and an associated manufacturing method which is simple to implement and applicable to all types of metal tubes, and in particular tubes with large lengths and small diameters.

To that end, the tube of the invention is essentially characterized in that it includes at least one attached radial bar fastened by welding to the internal face of the wall of the tube.

Preferably, this tube is provided with several attached radial bars regularly distributed circumferentially on the internal face of its wall.

Moreover, one can provide that each bar is rectangular in rectangular transverse section.

According to one advantageous embodiment, the tube of the invention comprises six attached radial bars which are regularly distributed circumferentially on the internal face of the wall of the tube and which extend over the entire length of the tube whereof the internal diameter is between 50 and 60 millimeters, and each of the bars has, in cross-section, a height between 8 and 15 millimeters and a width between 3 and 5 millimeters.

Advantageously, each bar is fastened to the internal face of the wall of the tube by a continuous weld line.

But one can alternatively provide that each bar is fastened to the internal face of the wall of the tube by a discontinuous weld line.

Preferably, the tube of the invention includes, on its external face, at least one continuous or discontinuous rib resulting from the welding of the bars on the internal face of the wall of the tube from the outside of the tube.

According to one advantageous aspect of the invention, each bar is made of an alloy with the following composition:

| Element | Composition (%) |
|---|---|
| C | 0-0.25 |
| Mn | 0-2 |
| Ph | 0-0.045 |
| S | 0-0.03 |
| Si | 1-2 |
| Cr | 24-26 |
| Ni | 19-22 |

The rest being iron.

According to another advantageous aspect of the invention, the tube is centrifugally cast and made of a creep-resistant alloy.

In the latter case, the tube is preferably made of an alloy chosen among the following two compositions:

| Element | Percentage |
|---|---|
| C | 0.45-0.50 |
| Mn | 0-1.5 |
| Si | 1-2 |
| P | 0-0.03 |
| S | 0-0.03 |
| Ni | 33-36 |
| Cr | 24-27 |
| Mo | 0-0.5 |
| Nb | 0.5-1 |
| Ti, Zr, W | Additions |

The rest being iron, or

| Element | Percentage |
|---|---|
| C | 0.40-0.50 |
| Mn | 0-1.5 |
| Si | 1-2 |
| P | 0-0.03 |
| S | 0-0.03 |
| Ni | 43-48 |
| Cr | 34-37 |
| Nb | 0.5-1 |
| Ti, Zr, W | Additions |

The rest being iron.

The invention also relates to a method for manufacturing the tube previously described, said method including at least one step for electron-beam welding from the outside of the tube of at least one attached radial bar on the internal face of the wall of the tube.

Preferably, this method comprises at least the following steps:
insertion into the tube of a bar-holder including at least one housing for receiving a bar to be welded,
placement of the bars to be welded on the bar-holder before or after the introduction of the bar-holder into the tube,
the placement of the bars to be welded in the tube at a distance close to the internal face of the wall of the tube, either by insertion of the bar-holder previously equipped with bars, or by the insertion of the bars on the bar-holder previously introduced into the tube,
electron-beam welding from the outside of the tube of the bars on the internal face of the wall of the tube, and
removal of the bar-holder.

Furthermore, the invention also relates to another method for manufacturing the tube described above, which includes at least one step for laser-beam welding from the outside of the tube of at least one radial bar on the internal face of the wall of that tube.

Lastly, the tubes previously described are applicable in petrochemical furnaces such as reforming or steam cracking furnaces, or in heating furnaces of direct reduction iron facilities.

BRIEF DESCRIPTION OF DRAWING FIGURES

The invention will be better understood, and other aims, features, details and advantages thereof will appear more clearly upon reading the following explanatory description done in reference to the appended diagrammatic drawings provided solely as an example illustrating several embodiments of the invention and in which:

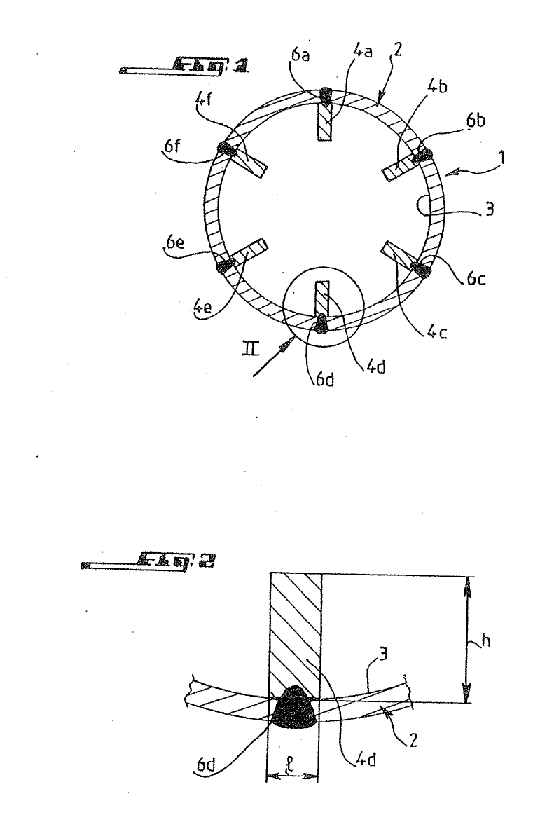

FIG. 1 is a diagrammatic illustration of a transverse section of the tube of the invention according to a first alternative;

FIG. 2 is an enlarged view of the circled portion noted II in FIG. 1;

FIGS. 3, 4, 5, 6 and 7 are diagrammatic illustrations according to the first alternative embodiment of the invention which illustrate, in order, the steps of the method of the invention;

FIG. 3 is a transverse cross-sectional view of a tube from the interior of that tube in which a bar-holder is introduced around which are arranged rings for maintaining bars mounted on the bar-holder,

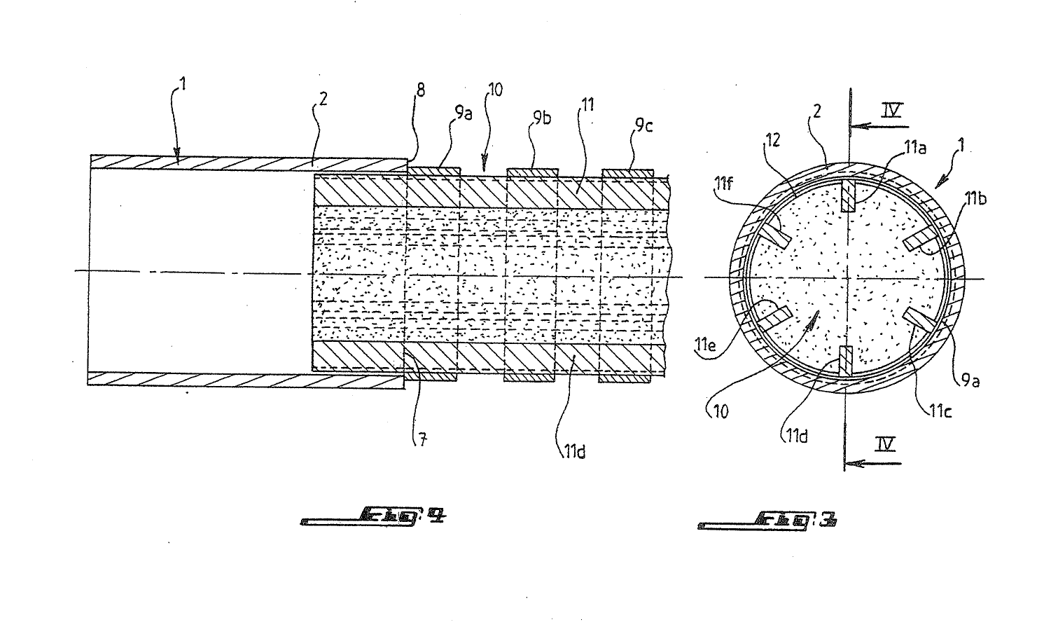

FIG. 4 is a longitudinal cross-sectional view of the tube from the interior of that tube wherein the bar-holder is introduced along the arrows IV-IV of FIG. 5;

FIG. 5 is a transverse cross-section of a tube in which the bar-holder and the bars have been introduced;

FIG. 6 is a transverse cross-sectional view of the tube and illustrates the electron-beam welding step of the bars;

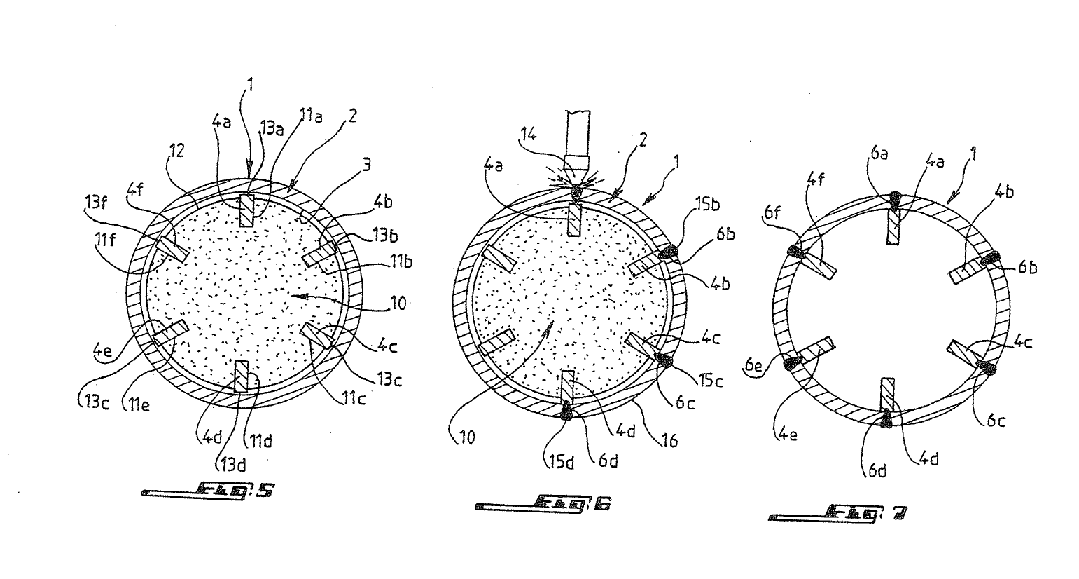

FIG. 7 is a transverse cross-sectional view of the tube of the invention after removal of the bar-holder;

FIG. 8 is a side view of the tube of the invention on which only one bar is illustrated, showing the continuous weld line realized to fasten a bar on the entire length of the tube;

FIG. 9 is a cross-sectional view along line IX-IX of FIG. 8;

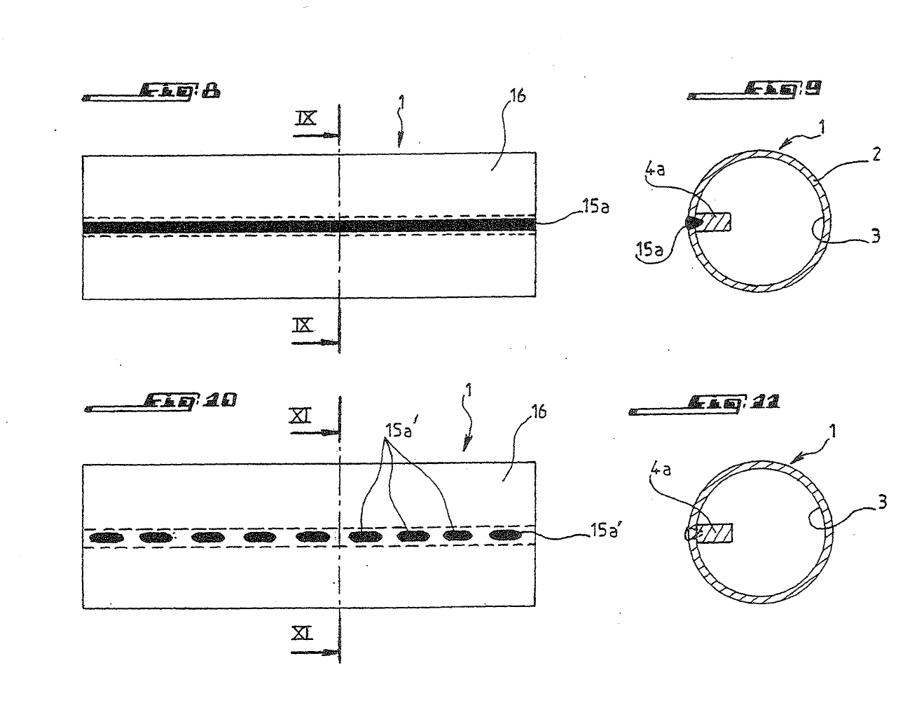

FIG. 10 is a side illustration of the tube of the invention on which only one bar is shown, diagrammatically showing the discontinuous weld line to fasten a bar on the entire length of the tube; and

FIG. 11 is a cross-sectional view along line XI-XI of FIG. 10.

### DETAILED DESCRIPTION

In reference to FIGS. 1 and 3, a tube 1 includes a cylindrical wall 2 with a thickness between 5 and 20 millimeters on the internal face 3 of which are regularly distributed, circumferentially, six radial bars 4a, 4b, 4c, 4d, 4e, 4f.

The length of the tube is 2.8 meters and its internal diameter is 54 millimeters.

The six bars 4a, 4b, 4c, 4d, 4e, 4f extend over the entire length of the tube 1.

The tube is centrifugally cast and realized in an alloy, the composition of which is chosen from the following:

| Element | Percentage |
|---|---|
| C | 0.45-0.50 |
| Mn | 0-1.5 |
| Si | 1-2 |
| P | 0-0.03 |
| S | 0-0.03 |
| Ni | 33-36 |
| Cr | 24-27 |
| Mo | 0-0.5 |
| Nb | 0.5-1 |
| Ti, Zr, W | Additions |

The rest being iron, or

| Element | Percentage |
|---|---|
| C | 0.40-0.50 |
| Mn | 0-1.5 |
| Si | 1-2 |
| P | 0-0.03 |
| S | 0-0.03 |
| Ni | 43-48 |
| Cr | 34-37 |
| Nb | 0.5-1 |
| Ti, Zr, W | Additions |

The rest being iron.

The composition of the bars in sheet metal is the following:

| Element | Composition (%) |
|---|---|
| C | 0-0.25 |
| Mn | 0-2 |
| Ph | 0-0.045 |
| S | 0-0.03 |
| Si | 0-1.5 |
| Cr | 24-26 |
| Ni | 19-22 |

The rest being iron.

The materials used for the tube and for the bars both have similar thermo-physical properties, in particular regarding the expansion coefficient.

These two materials also have a high resistance to carburizing due to their austenitic structure and high chrome content.

According to a first alternative visible in FIGS. 1 and 2, each bar 4a, 4b, 4c, 4d, 4e, 4f has a rectangular cross-section.

More precisely, one provides, in this alternative, a bar height h of 12 millimeters for a width 1 of 4 millimeters.

As shown in FIGS. 1 and 2, a weld seam 6a, 6b, 6c, 6d, 6e, 6f fastens each corresponding bar 4a, 4b, 4c, 4d, 4e, 4f to the internal face 3 of the wall 2 of the tube 1. The presence of this weld seam 6a, 6b, 6c, 6d, 6e, 6f results from the method used to fasten each bar 4a, 4b, 4c, 4d, 4e, 4f to the wall 2 of the tube 1.

This method is described in reference to FIGS. 3 to 7.

A bar-holder 10 assumes the form of full tube with diameter smaller than the diameter of the internal face 3 of the wall 2 of the tube 1.

The bar-holder 10 has six radial housings 11a, 11b, 11c, 11d, 11e, 11f for receiving bars 4a, 4b, 4c, 4d, 4e, 4f. These housings 11a, 11b, 11c, 11d, 11e, 11f are regularly distributed circumferentially on the external edge 12 of the bar-holder 10.

Each housing 11a, 11b, 11c, 11d, 11e, 11f is joined with the bar 4a, 4b, 4c, 4d, 4e, 4f it receives.

In the example shown in FIG. 3, the bars 4a, 4b, 4c, 4d, 4e, 4f have a rectangular section. Each housing 11a, 11b, 11c, 11d, 11e, 11f is such that each bar 4a, 4b, 4c, 4d, 4e, 4f can be kept in place in its respective housing.

Each bar 4a, 4b, 4c, 4d, 4e, 4f is introduced into its respective housing 11a, 11b, 11c, 11d, 11e, 11f on the bar-holder 10.

The bars 4a, 4b, 4c, 4d, 4e, 4f are kept in position on the bar-holders 10 by several circular rings 9a, 9b, 9c which surround the bar-holder while keeping the bars 4a, 4b, 4c, 4d, 4e, 4f in place in their housing.

Then, the assembly formed by the bar-holder 10 and the bars 4a, 4b, 4c, 4d, 4e, 4f is introduced into the tube 1.

When the bar-holder 10 slides in the tube 1, the ring 9a closest to the inlet 7 of the tube 1 bears against the external edge 8 of the wall 2 of the tube 1 as illustrated in FIG. 6.

The bar-holder 10 continues its travel in the tube 1 by sliding relative to the first ring 9a still bearing against the external edge 8 of the wall 2 of the tube 1.

Then, the second ring 9b then bears against the first ring 9a and the bar-holder 10 continues its travel in the tube 1. This configuration is not shown in the figures.

The same is true for the following rings 9c.

When the bar-holder 10 is completely in place in the tube 1, the rings 9a, 9b, 9c are received. This step is illustrated in FIG. 7 which, in comparison with FIG. 5, does not show the ring 9a.

In reference to FIG. 5, the height of each housing 11a, 11b, 11c, 11d, 11e, 11f on the bar-holder 10 is such that the base 13a, 13b, 13c, 13d, 13e, 13f of each of the bars 4a, 4b, 4c, 4d, 4e, 4f is flush with the internal face 3 of the wall 2 of the tube 1.

When the bar-holder 10 is in place in the tube 1, the step then begins for fastening the bars 4a, 4b, 4c, 4d, 4e, 4f.

As shown in FIG. 6, each bar 4a, 4b, 4c, 4d, 4e, 4f is welded to the wall 2 of the tube 1 by vacuum electron-beam welding done from outside the tube 1.

The electron beam 14 penetrates the thickness of the wall 2 of the tube 1 while generating enough heat to cause the melting of the wall 2 of the tube 1 at that location on one hand, and the melting of the end of the bar 4a close to the internal face 3 of the wall 2 of the tube on the other hand, which causes the welding of the bar 4a to the wall 2 of the tube 1 and the fastening of each bar 4a, 4b, 4c, 4d, 4e, 4f to the internal face 3 of the wall 2 of the tube 1.

The bars 4a, 4b, 4c, 4d, 4e, 4f are welded one by one on the entire length of the tube 1. To do this, the electron beam 14 is applied on the tube 1 in the direction of a bar 4a from the inlet 8 of the tube 1 and this electron beam 14 undergoes a linear travel over the entire length of the tube 1 until the end of the tube 1 not shown in the figures.

Alternatively, one can provide that it is the tube 1 which translates under the electron beam.

Marking of the position of the bars 4a, 4b, 4c, 4d, 4e, 4f at the inlet of the tube is provided.

Once each bar 4a, 4b, 4c, 4d, 4e, 4f has been welded over the entire length of the tube 1, the bar-holder 10 is withdrawn from the tube 1 by longitudinal sliding.

Thus obtained is a tube 1 like that of FIG. 9 having an increased internal surface and which can be used in steam cracking, reforming or DRI furnaces.

The welding seam 6b, 6c, 6d resulting from the electron-beam 14 welding step previously described is detectable by analysis.

Indeed, this seam has a particular structure, resulting from a solidification after fusion of the wall of the tube and of the bar. A micrographic analysis can make it possible to observe the presence of a fusion zone making it possible to fasten a bar on the internal face 3 of the tube 1.

Moreover, the electron-beam welding causes, at each weld point, a blister 15a protruding on the external face 16 of the tube.

In reference to FIGS. 10 to 13, the fastening of a bar 4a on the internal face 3 of the tube 1 can be done either by a continuous weld line 15a on the entire length of the tube (FIGS. 10 and 11), or by a discontinuous weld line on the length of the tube 1 (FIGS. 12 and 13).

In the case of a continuous weld, the external face 16 of the tube 1 will have a rib 15a extending along the tube 1 and indicating the presence of a bar 4a fastened to the internal face 2 of the wall 2 of the tube 1 under this blister 15a.

And in the case of a discontinuous weld, the external face 16 of the tube 1 will include a line of discontinuous blisters 15a′, also marking the presence of a bar 4a fastened to the internal face 2 of the wall 2 of the tube 1 under said line 15a.

Creep tests through the weld seam were conducted. These tests demonstrate that the properties of the tube were not altered.

The tests consist of evaluating the rupture time, in hours, under stress of 17 MPa at a temperature of 1100° C.

The results are as follows.

For the metal of the tube 1, the rupture time is greater than or equal to 100 hours. And for the metal melted at the weld seam, the rupture time is 114 hours.

The weld seam therefore has satisfactory properties to resist the stresses imposed in petrochemical furnaces.

Table 1 below presents the heat gain and friction loss evaluated by simulation for two tubes of the prior art and two tubes of the invention.

| Tube | dT (° C.) | dP (Pa) |
|---|---|---|
| Prior tube 1 | 0 | 0 |
| Prior tube 2 | 23 | 655 |
| Tube of the | 59 | 1846 |
| invention 1 | | |
| Tube of the | 39 | 900 |
| invention 1 | | |

The prior tube 1 is a tube with a circular internal surface in cross-section.

The prior tube 2 is a tube whereof the internal section has hollows and protuberances like that obtained by the methods described in applications EP 980 729 and WO 03/011507.

The tube of the invention 1 is that of FIGS. 1 and 2, and the tube of the invention 2 is that of FIGS. 3 and 4.

dT is the difference between the temperature of the gas at the outlet of the considered tube and the temperature of the gas at the outlet of prior tube 1.

dP is the friction loss between the inlet and the outlet of the considered tube.

One sees that the heat transfer gain is more significant for the tubes of the invention than for a tube including hollows and protuberances on its internal surface. Regarding the friction loss, the friction loss for the tube of the invention 1 is more significant but remains acceptable and the friction loss in the tube of the invention 2 is completely satisfactory.

These results show the effectiveness in terms of heat exchange and friction loss of the tube of the invention.

The fastening of the bars on the internal face of a tube by welding from the outside of the tube presents many advantages.

First, it avoids the insertion of the device for fastening bars inside the tube, making the manufacture of the tube simpler.

Moreover, the weld seam which ensures the connection between the bars and the tube is capable of resisting the heat and mechanical operating stresses of the tube at high temperatures.

Moreover, the extra weight provided by the bars is much less than that provided by the protuberances and the hollows of the tubes described in the applications for patents EP 980729 and WO 03,011507 since one sees a reduction of the extra weight by about half on the tube of the invention. This allows the tube of the invention to be more easily installed suspended in the furnaces.

Moreover, this seam ensures a thermal bridge between the tube and the bar.

Also additionally, through this method, it is possible to choose the material of the bars according to the later usage conditions of the tube.

But also, this method is applicable to all types of metal tubes, whether they are forged or centrifugally cast.

As an alternative to electron-beam welding, one can use laser welding.

One could also consider different geometries of the bars.

One can also imagine the presence of bars on only one portion of the length of the tube to limit the friction losses.

In this sense, one could consider having the radial bars assume the form of segments regularly distributed on the length of the tube.

The welding method for manufacture leaves great freedom to choose both the materials to be used and the configuration of the bars to be adopted, resulting in an effectiveness as least equal to that of the known tubes with increased internal surface.

1. A tube structure used in furnaces, comprising:
a tube having a wall with an internal face; and
at least one radial bar fastened to the internal face the wall of the tube.

2. The tube structure according to claim 1, including a plurality of the radial bars uniformly distributed circumferentially on the internal face of the wall of the tube.

3. The tube structure according to claim 1, wherein each radial bar is rectangular in transverse section.

4. The tube structure according to claim 3, comprising six attached radial bars uniformly distributed circumferentially on the internal face of the wall of the tube and which extend over the entire length of the tube, wherein
the tube has an internal diameter between 50 and 60 millimeters, and
each radial bar has, in cross-section, a height between 8 and 15 millimeters and a width between 3 and 5 millimeters.

5. The tube structure according to claim 1, wherein each radial bar is fastened to the internal face of the wall of the tube at a continuous weld line.

6. The tube structure according to claim 1, wherein each radial bar is fastened to the internal face of the wall of the tube along a discontinuous weld line.

7. The tube structure according to claim 1, including, on an external face of the tube, at least one rib where the bars are attached to the internal face of the wall of the tube.

8. The tube structure according to claim 1, wherein each bar is an alloy having the following composition:

| Element | Composition (5) |
|---|---|
| C | 0-0.25 |
| Mn | 0-2 |
| Ph | 0-0.045 |
| S | 0-0.03 |
| Si | 0-1.5 |
| Cr | 24-26 |
| Ni | 19-22 |

, the rest being iron.

9. The tube structure according to claim 1, wherein the tube is a creep-resistant alloy.

10. The tube structure according to claim 9, wherein the tube is made of an alloy having a composition chosen from the following:

| Element | Percentage |
|---|---|
| C | 0.45-0.50 |
| Mn | 0-1.5 |
| Si | 1-2 |
| P | 0-0.03 |
| S | 0-0.03 |
| Ni | 33-36 |
| Cr | 24-27 |
| Mo | 0-0.5 |
| Nb | 0.5-1 |
| Ti, Zr, W | Additions |

, the rest being iron, or

| Element | Percentage |
|---|---|
| C | 0.40-0.50 |
| Mn | 0-1.5 |
| Si | 1-2 |
| P | 0-0.03 |
| S | 0-0.03 |
| Ni | 43-48 |
| Cr | 34-37 |
| Nb | 0.5-1 |
| Ti, Zr, W | Additions |

, the rest being iron.

11. A method for manufacturing the tube structure of claim 1, comprising electron-beam welding, from the outside of the tube of the at least one radial bar onto the internal face of the wall of the tube.

12. The method according to claim 11, comprising
inserting into the tube of a bar-holder including at least one housing for receiving a radial bar to be welded,
placing the radial bars to be welded on the bar-holder,
placing the radial bars to be welded in the tube close to the internal face of the wall of the tube,
electron-beam welding, from the outside of the tube, the radial bars onto the internal face of the wall of the tube, and
removing the bar-holder.

13. A method for manufacturing the tube structure of claim 1, including laser-beam welding, from the outside of the tub, at least one radial bar onto the internal face of the wall of the tube.

14. (canceled)
